(19) United States
(12) Patent Application Publication
(10) Pub. No.: US 2001/0041751 A1
(43) Pub. Date: Nov. 15, 2001

(54) Polymerization process for preparing crosslinked copolymers

(76) Inventors: Ralf-Jurgen Born, Monheim (DE); Olaf Halle, Koln (DE); Martin Hecker, Paderborn (DE); Hans-Ulrich Moritz, Bendestorf (DE)

Correspondence Address: Patent Department, Bayer Corporation, 100 Bayer Road, Pittsburgh, PA, 15205-9741, US

(21) Appl. No.: 09/873,790

(22) Filed: Jun. 4, 2001

Related U.S. Application Data
(62) Division of application No. 09/393,177, filed on Sep. 9, 1999.

(30) Foreign Application Priority Data
Sep. 11, 1998 (DE) 19841510.9

(51) Int. Cl. C08J 5/20

(52) U.S. Cl. 521/25; 526/336; 526/90

(57) ABSTRACT

The present invention relates to a process for polymerizing a mixture of one or more monovinyl monomers and one or more polyvinyl monomers in the presence of

(1) one or more free-radical initiators, and

(2) 0.005 to 5% by weight, calculated as metal and based on the weight of the polyvinyl monomers, of at least one metal compound from the 1st, 2nd, or 8th transition group of the periodic table,

with the proviso that one or more nonionic dispersants are present as stabilizers if the polymerization is carried out by suspension polymerization.

### BACKGROUND OF THE INVENTION

The invention relates to a polymerization process for preparing crosslinked copolymers obtained by free-radical polymerization of a polyvinyl and a monovinyl compound, to the polymers themselves, and to their use as base polymers for producing ion exchangers, adsorbers, chromatography columns, or other useful materials.

The polymerization for this purpose may be carried out in bulk, for example, in a kneader or extruder, or in solution or suspension. The resultant crosslinked copolymers can then be used, for example, as starting compounds for ion exchangers, adsorbers, chromatography columns, or other useful materials. Besides the form of the polymer, which is primarily determined by the mechanical process operations used, certain polymer properties determine the usability of the crosslinked resins in downstream processes. These are, first, swellability and, second, the fraction, known as the soluble fraction, that can be dissolved out from the copolymer by extraction.

DE 3,200,968 describes a suspension polymerization process in which a mixture made from a monovinyl monomer and a polyvinyl monomer is polymerized in suspension, using carboxymethylcellulose as ionic dispersant, with from 0.5 to 10% by weight, calculated as metal and based on the weight of the carboxymethylcellulose, of at least one metal compound from the group consisting of iron, zinc, and copper that is present in the aqueous phase of the polymerization system. However, a disadvantage of this process is a shifting of the particle size profile to larger particle sizes. It would be desirable to find a process in which the particle size distribution of the target particle (from 0.1 to 0.6 mm) remains unchanged while the polymer properties are changed (greater swellability with the same soluble fraction).

DD 56,936 describes a process for preparing bead-shaped polymers and copolymers in aqueous suspension, particularly styrene and divinylbenzene, alone or mixed. To achieve a narrow particle size profile, according to this patent, from 0.0025 to 0.5% of Cu(I) salts, based on the amount of monomer used, were added to the aqueous phase to promote the stabilization of the aqueous phase with polyvinyl alcohols. The bead polymers prepared using the information in this patent have the disclosed particle size distribution, but swellabilities are only average and the weight of the soluble fraction is too high.

The swellability of the product and its soluble fraction should be regarded as different factors. A certain degree of swellability of the copolymers is unavoidable if the requirements for process steps that follow, and for subsequent applications, are to be met. In contrast, the presence of a soluble fraction is undesirable: some of the starting material is not a constituent of the network and is dissolved out during later process steps. This gives losses in the yield and value of the copolymer.

Both of the variables are inversely related to the content of crosslinking agent, i.e., to the content of the polyvinyl component. If less crosslinking agent is used, the result is an open polymer network, which is likely to have high swellability but also a high soluble fraction. Successive increase in the content of crosslinking agent in the reaction mixture depresses the soluble fraction, but this is associated with increasingly poor swellability.

The ratio between the two variables is primarily dependent on the chemical behavior of the monomers and on the conduct of the polymerization reaction.

In copolymerizations of monovinyl with divinyl compounds it has been found that the incorporation of the crosslinking divinyl compounds into the copolymer is mostly faster than that of the monovinyl compounds. The r value, which describes the ratio of the incorporation rates of mono and polyvinyl compound, is in this specific example 0.23 for styrene/p-divinylbenzene and 0.43 for styrene/m-divinylbenzene. This means that the crosslinking compound is incorporated into the polymer more than four times as rapidly as the monovinyl compound in the first example and more than twice as rapidly in the second example.

At low contents of crosslinking agent, a very high fraction of the total polymer material is not bonded in the network and is, therefore, lost for any further process steps. Crosslinked polymers, therefore, strike a compromise between swellability and the extent of the fraction which can be dissolved out.

The journal Macromolecules, 30, 4073-4077 (1997) discusses the extent to which the reactivity of the network-forming polyvinyl component determines the homogeneity and, therefore, also the swellability, as well as the soluble fraction, of polymer networks. The text makes it clear that in batch polymerizations the properties of the polymer network can be modified only by selecting a different crosslinking agent.

When preparing polymers, it is advantageous to use the same amount and the same type of crosslinking agent to form a relatively homogeneous polymer network that has high swellability without increasing the soluble fraction. At the same time, the form of the polymer resulting from the production process should remain unchanged through this optimization. In the case of suspension polymerization, this is the average diameter of the bead within the target range for the particles.

Examples of possible reaction systems are the use of semibatch processes in which the polyvinyl component is metered into the reaction material during the course of the reaction. Seed-feed processes are also used. Both methods prevent impoverishment of the reaction system in the faster-reacting polyvinyl component at higher conversions.

However, these process steps imply complicated control techniques. In the case of the seed-feed polymerization, which sometimes gives only interpenetrating networks, the preparation process has a plurality of stages and the production process must be interrupted. Substitution of the polyvinyl components here is possible only in exceptional cases, since it plays a decisive part in determining the physical properties (stability) of the network. There is, therefore, a need for a process that uses the same crosslinking agent and the same contents of crosslinking agent to prepare a polymer network that has increased swellability without any increase in the fraction that can be dissolved out.

It has now been found that polymers with higher swellability can be obtained if the polymerization is carried out in the presence of a metal compound. In the case of the suspension polymerization, the average particle diameter of the beads remains unchanged in the range below 1 mm.

### SUMMARY OF THE INVENTION

The invention relates to a polymerization process comprising polymerizing a mixture of one or more (preferably one to three) monovinyl monomers and one or more (preferably one to four) polyvinyl monomers in the presence of

(1) one or more free-radical initiators, and

(2) 0.005 to 5% by weight (preferably from 0.01 to 2% by weight), calculated as metal and based on the weight of the polyvinyl monomers, of at least one metal compound from the 1st, 2nd, or 8th transition group of the periodic table,

with the proviso that one or more nonionic dispersants are present as stabilizers if the polymerization is carried out by suspension polymerization.

### DETAILED DESCRIPTION OF THE INVENTION

Surprisingly, the novel process gives crosslinked copolymers that differ from the prior art in having markedly improved swellability performance.

Examples of monovinyl monomers that can be used according to the invention are substances containing a polymerizable C═C double bond and, if desired, having halogen, alkyl, alkoxy, or phenyl substitution. Examples of such monovinyl compounds are styrene, ethylstyrene, isopropylstyrene, n-propylstyrene, butylstyrene, chlorostyrene, methoxystyrene, and tert-butoxystyrene.

Examples of polyvinyl monomers that may be used according to the invention are compounds containing at least two C═C double bonds in their basic skeleton and, if desired, having halogen, alkyl, alkoxy, or phenyl substitution. Examples of such polyvinyl compounds are divinylbenzene, divinyltoluene, divinylxylene, aryldivinyl-benzene, and halogenodivinylbenzene.

Preference is given to the use of a mixture made from a monovinyl monomer such as styrene as principal component and from a polyvinyl monomer such as commercially available divinylbenzene isomers as principal component in the presence of copper(I) chloride.

Although the ratio of monovinyl monomer to polyvinyl monomer may vary over a wide range depending on the application of the polymers obtained, the amount of the polyvinyl monomer is generally from 0.05 to 100% by weight (preferably from 0.1 to 10% by weight), based on the weight of the monovinyl component.

Examples of polymerization initiators suitable for the novel process are peroxy compounds, such as dibenzoyl peroxide, dilauroyl peroxide, bis(p-chlorobenzoyl) peroxide, dicyclohexyl peroxydicarbonate, tert-butyl peroctoate, 2,5-bis(2-ethyl-hexanoylperoxy)-2,5-dimethylhexane and tert-amylperoxy-2-ethylhexane, and azo compounds, such as 2,2′-azobis(isobutyronitrile) and 2,2′-azobis(2-methyl-isobutyronitrile). The amounts of the initiators generally used are from 0.05 to 2.5% by weight (preferably from 0.2 to 1.5% by weight), based on the total of monomer and crosslinking agents.

Other additives that may be used in the mixture are those known as porogens, which create a macroporous structure in the polymer. Compounds suitable for use as porogens are organic solvents that are poor solvents and/or swelling agents for the polymer formed. Examples are hexane, octane, isooctane, isododecane, methyl isobutyl ketone, and octanol.

The polymerization temperature depends on the decomposition temperature of the initiator used but is generally from 50 to 150° C. (preferably from 55 to 100° C.). The polymerization takes from 0.5 hour to a few hours. It has proven useful to use a temperature program in which the polymerization begins at low temperature (e.g., 60° C.) and the reaction temperature is raised as the conversion in the polymerization increases. This method is very successful in fulfilling, for example, the requirement for reliable conduct of the reaction and high conversion in the polymerization.

If the novel polymerization process is applied to, for example, suspension polymerizations, nonionic dispersants must be present as suspension stabilizers, as should a buffer system where appropriate. Preferred dispersants are natural or synthetic water-soluble polymers, for example, gelatin, starch, polyvinyl alcohol, polyvinylpyrrolidone, or copolymers of (meth)acrylates. Other very suitable compounds are etherified celluloses, such as hydroxyethylcellulose derivatives, methyl-hydroxyethylcellulose derivatives, or methylhydroxyethylcellulose derivatives, if possible without ionic carboxyl groups in order to avoid shifting the particle size profile undesirably to higher bead diameters.

When carrying out the polymerization process of the invention as a suspension polymerization, it is generally preferred to use a dispersed phase forming a proportion of from 10 to 60% of the total weight.

A significant factor in the present invention is the use in the reaction of at least one compound of a metal selected from the class consisting of the 1st, 2nd, or 8th transition group of the periodic table, preferably silver or copper in oxidation state I. Compounds of this type may be any compound that does not adversely affect the polymerization system. For example, it is generally possible to use halides, such as chlorides or bromides, pseudohalides, inorganic salts, such as sulfates, nitrates, or phosphates, organic acid salts, such as oxalates or acetates, or hydroxides or oxides of the above-mentioned metals.

The amount of the metal compound is from 0.005 to 5% by weight (preferably from 0.001 to 2% by weight), calculated as metal and based on the weight of the polyvinyl compound. If the amount added is too small, it is ineffective, and if the amount is too large, the polymerization may be inhibited.

It is important that the metal compound be added to the organic phase (oil phase) before the polymerization begins. This is particularly significant when suspension polymerization processes are used. Thorough mixing then follows to ensure that the compound is homogeneously distributed in the reaction system (oil phase).

The novel process is generally carried out under atmospheric pressure. However, it is also possible to carry out the process at an overpressure of up to 100 bar.

The novel process gives crosslinked copolymers that have higher swellability without any significant increase in their soluble fraction and, in the case of a suspension polymerization, without any change in the average diameter of the beads in the range below 1 mm.

The following Examples and Comparative Examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

In the novel process the metal compound was added to the crosslinking agent prior to the reaction. This produced, in situ, a stock solution of the polyvinyl component (here, for example, divinylbenzene at 80% purity) and the metal salt (type and weight as in Table 1). After thorough mixing, some of this stock solution (polyvinyl component and specified amount of metal) was used directly to prepare the reaction solution.

TABLE 1

| Stock solution no. | Metal salt | Weight (g) |
|---|---|---|
| 1 (inventive) | Cu₂Cl₂ | 0.334 |
| 2 (inventive) | Ag(NO)₃ | 1.088 |
| 3 (comparison) | No salt | — |

All data in Table 1 are based on 100 g of divinylbenzene (80% purity)

### Example 1

1 g of styrene and 0.017 g of the respective stock solutions (1 or 3) were charged under nitrogen to a glass flask (volume 5 ml) that could be sealed with stoppers and were mixed with 0.005 g of pure dibenzoyl peroxide. The polymerization was started by heating to 70° C. in an oil bath, where the flask remained for the entire reaction time (12 hours). During the last hour the oil bath temperature was increased to 85° C. After cooling to room temperature, the polymer was removed from the flask, weighed, and transferred into toluene (as extractant and swelling agent). The degree of swelling (ratio of swollen weight to weight of unswollen polymer) was calculated from the weight increase of the swollen polymer. Another specimen was extracted for 12 hours using a Soxhlet apparatus with toluene as solvent. All of the extract was transferred into a weighed flask and the extractant was removed slowly under high vacuum on a rotary evaporator. The fraction of soluble, uncrosslinked polymers (soluble fraction) was calculated from the ratio of the flask residue weight and the starting weight of polymer. Results are given in Table 2.

TABLE 2

| Reaction mixture | Soluble fraction | Degree of swelling |
|---|---|---|
| Stock solution 1 (inventive) | 2.4% | +8.30% |
| Stock solution 3 (comparison) | 2.3% | +7.30% |

### Example 2

11.5 g of hydroxyethylcellulose and 768 g of water were charged to a 2.5 liter glass reactor provided with stirrer, temperature control, and a nitrogen inlet. The organic phase was prepared from 259 g of styrene, 4.5 g of divinylbenzene from a stock solution (see Table 1 for selection), and 1.37 g of dibenzoyl peroxide and then added to the aqueous phase with stirring at 100 rpm (revolutions per minute) under a stream of nitrogen. The rotation rate was increased to 140 rpm and the mixture was then heated to 70° C. and held at this temperature for 10 hours. After heating to 85° C. and after a further reaction time of 2 hours, the bead polymer could be separated from the mixture. An accurately weighed amount of bead polymer was extracted with toluene and the soluble fraction was calculated from the evaporation residue from the extractant (ratio of residue weight to starting weight of polymer). The degree of swelling was determined from the volume increase of a bed of beads (ratio of volumes of swollen and unswollen polymer). Results are given in Table 3.

TABLE 3

| | Soluble | Degree of | Average bead diameter |
|---|---|---|---|
| Reaction mixture | fraction | swelling | in the range below 1 mm |
| Stock solution 1 | 2.4% | +6.8% | 0.38 |
| (inventive) | | | |
| Stock Solution 2 | 2.6% | +6.5% | 0.34 |
| (inventive) | | | |
| Stock solution 3 | 2.4% | +6.0% | 0.35 |
| (comparison) | | | |

The examples and comparative examples show that the novel process of the invention prepares polymer networks that have increased swellability at constant soluble fraction and, in the case of suspension polymerization, without any shift in the average diameter of the beads in the range below 1 mm to poorer values.

What is claimed is:

1. A polymerization process comprising polymerizing a mixture of one or more monovinyl monomers and one or more polyvinyl monomers in the presence of
(1) one or more free-radical initiators, and
(2) 0.005 to 5% by weight, calculated as metal and based on the weight of the polyvinyl monomers, of at least one metal compound from the 1st, 2nd, or 8th transition group of the periodic table,
with the proviso that one or more nonionic dispersants are present as stabilizers if the polymerization is carried out by suspension polymerization.

2. A process according to claim 1 wherein the amount of the polyvinyl monomer, based on the weight of the monovinyl component, is from 0.05 to 100% by weight.

3. A process according to claim 1 wherein the principal components present in the polyvinyl component and the monovinyl component are substances containing polymerizable C═C double bonds.

4. A process according to claim 1 wherein the monovinyl or polyvinyl components have halogen, alkyl, alkoxy, or phenyl substituents in addition to the C═C double bonds.

5. A process according to claim 1 wherein the metal compound is a halide, a pseudohalide, or a salt of an inorganic or organic acid.

6. A process according to claim 1 wherein the metal compound is a chloride or a nitrate compound.

7. A process according to claim 1 wherein the metal compound contains copper in the oxidation state 1.

8. A process according to claim 1 wherein the polymerization is carried out within a temperature range from 50 to 150° C. in the presence of from 0.05 to 2.5% by weight, based on the total weight of the monomers, of a free-radical polymerization initiator.

9. A process according to claim 1 wherein one or more porogens are present in an amount not exceeding 55% of the total weight of the reaction mixture.

10. A process according to claim 1 wherein suspension polymerization is carried out using a dispersed phase forming a proportion of from 10 to 60% of the total weight.

11. A polymer prepared by a process comprising polymerizing a mixture of one or more monovinyl monomers and one or more polyvinyl monomers in the presence of
(1) one or more free-radical initiators, and
(2) 0.005 to 5% by weight, calculated as metal and based on the weight of the polyvinyl monomers, of at least one metal compound from the 1st, 2nd, or 8th transition group of the periodic table.
with the proviso that one or more nonionic dispersants are present as stabilizers if the polymerization is carried out by suspension polymerization.

12. A method for preparing ion exchangers, adsorbers, chromatography columns, or useful materials from a base polymer comprising modifying a polymer prepared according to the process of claim 1.
